(19) United States
(12) Patent Application Publication
(10) Pub. No.: US 2026/0168778 A1
(43) Pub. Date: Jun. 18, 2026

(54) WHEEL-FITMENT DEVICE

(71) Applicant: Clayton L. Ramstead, Cedar Rapids, IA (US)

(72) Inventor: Clayton L. Ramstead, Cedar Rapids, IA (US)

(21) Appl. No.: 19/543,449

(22) Filed: Feb. 18, 2026

Related U.S. Application Data
(63) Continuation-in-part of application No. 18/348,598, filed on Jul. 7, 2023.
(60) Provisional application No. 63/367,836, filed on Jul. 7, 2022.
(60) Provisional application No. 63/759,838, filed on Feb. 18, 2025.

(51) Int. Cl. G01B 5/00; G01B 5/02; G01B 5/08

(52) U.S. Cl. CPC G01B 5/0025; G01B 5/02; G01B 5/08

(57) ABSTRACT

A wheel-fitment assembly enabling a physical mock-up of an optimal wheel geometry for a hub. The wheel-fitment assembly integrates into a unitary apparatus an offset measuring device, a diameter measuring device, and a width measuring device to simultaneously delineate and represent the optimal wheel's offset distance, diameter, and width. The width measuring device has two bidirectional sliding scales to simultaneously define an outer edge and inner edge of the wheel width wherein the two sliding scales are mechanically communicated by an adjustment link so that movement of one sliding scale directly affects or moves the position of the other sliding scale absent a user manually resisting such movement. The adjustment link may be an elongated rod with guide tracks, wherein each sliding scale may have guide fingers that ride along opposing ends of the same guide tracks, thereby enabling the simultaneous movement of the unrestricted two bidirectional sliding scales.

### CROSS REFERENCE TO RELATED APPLICATION

This application claims the benefit of priority of U.S. provisional application No. 63/759,838, filed Feb. 18, 2025, the contents of which are herein incorporated by reference. This application also claims the benefit of priority of U.S. provisional application No. 63/367,836, filed Jul. 7, 2022, the contents of which are herein incorporated by reference. This application also claims the benefit of priority of U.S. non-provisional application Ser. No. 18/348,598, filed Jul. 7, 2023, as a Continuation in Part thereof, the contents of which are herein incorporated by reference.

### BACKGROUND OF THE SUBJECT DISCLOSURE

The present subject disclosure relates to wheel-fitment tools and, more particularly, to an assembly adapted to engage a vehicular wheel hub so as to define the optimal combination of wheel width, wheel offset distance, and wheel diameter for the vehicular wheel hub, wherein the device embodies a bidirectional width measuring device that simultaneously determines the inner edge and outer edge of the wheel width so as to avoid inaccuracies when calculating the wheel width.

Testing wheel width, offset, and diameter on a vehicle before purchase or during replacement is critical because these dimensions collectively determine fitment, safety, and performance. Even if a wheel's bolt pattern matches, incorrect sizing can lead to expensive mechanical damage or dangerous handling. For instance, mechanical clearance and safety issues implicated by improper wheel fitment include brake interference, uneven tire wear, lack of full range of motion of the steering, and torque issues resulting from incorrect offset as well as warranty and insurance non-compliance.

Consumers and automotive professionals, unfortunately, lack a reliable way to accurately test for optimal or proper wheel width, offset, and diameter on a vehicle before purchasing wheels, which leads to frequent fitment errors, unnecessary returns, and costly wheel selection mistakes. Specifically, existing wheel-fitment tools often rely on multiple, separate components demanding separate steps and manual measurements to simulate and so determine the proper width, offset, and diameter base on the properties and dimensions of the naked wheel hub, making the overall setup and measurement process slow, cumbersome, and fraught with inaccuracies for the user.

In sum, existing wheel-fitment tools struggle to accurately estimate a wheel geometry based on the wheel hub since the tools lack the ability to simultaneously define all the key geometric properties (diameter, offset, and width as define by the distance between the inner and outer edges of the wheel) during the adjustable estimation process. Typically, because these tools generally require users to adjust each dimension independently, thereby introducing opportunities for user error and making it difficult to simultaneously maintain consistent, adjustable geometry measurements throughout the process. Their step-dependent setup also increases the chance of misalignment between measurements.

As can be seen, there is a need for an assembly for simultaneously determining the optimal combination of wheel width, wheel offset, and wheel diameter, wherein a width measuring device of the assembly is bidirectional in that the inner edge distance measurements are synchronized with the outer edge distance measurements.

### SUMMARY OF THE SUBJECT DISCLOSURE

The subject disclosure integrates dimensional calibration of an optimal wheel's width, diameter and offset distance into a unified assembly or system, including an integrated width measurement device enabling simultaneous bidirectional width calibration that preserves consistent geometry automatically. This interrelationship between calibration of an optimal inner edge and outer edge of a wheel width reduces setup complexity, minimizes user error, and allows faster, more precise and reliable fitment testing directly on the vehicle.

The subject disclosure enables a physical mock-up of an optimal wheel of a hub based on direct physical engagement of an assembly with the hub through the integration of an offset measuring device, a diameter measuring device and a width measuring device, wherein the width measuring device provides bidirectional sliding scales that calibrate inner edge location and the outer edge location, respectively, and wherein the two sliding scales are linked by an adjustment link that mechanically communicates the two sliding scales where movement of one sliding scale affects the position of the other. This overall assembly enables users to replicate wheel width, offset, and diameter directly on the vehicle, wherein the width measuring device synchronizes adjustable width calibration, thereby ensuring both sides or edges of the wheel width are interrelated, i.e., expand and contract in concert, which in turn enables accurate clearance determination. By enabling real-time, hands-on testing of wheel geometry, the subject disclosure eliminates guesswork and confirms proper fit before purchase.

In one aspect of the subject disclosure, a wheel-fitment device comprises a removable mounting interface configured to engage a vehicle hub, a diameter-defining member extending radially from the mounting interface, and a synchronized width-adjustment mechanism configured to move opposing width-defining components in coordinated fashion.

In another aspect of the subject disclosure, a method of simulating wheel width, offset, and diameter on a vehicle hub comprises mounting the device to the hub, adjusting the synchronized width-adjustment mechanism to establish a desired wheel width, and positioning the device to define simulated offset and diameter.

In yet another aspect of the subject disclosure, a wheel-fitment assembly for determining geometric properties of an optimal wheel for a hub includes the following: a removable mounting interface configured to engage the hub of a vehicle so as to define a reference point; a diameter measuring device operatively associated with the removable mounting interface so that the diameter measuring device extends radially upward relative to the engaged hub; an adjustment housing providing offset measurement indicia, wherein the adjustment housing is slidably coupled to a distal end of the diameter measuring device so that the adjustment housing is linearly movable in a direction parallel to an axis of rotation of the engaged hub to define an offset distance of said optimal wheel relative to the reference point; and a width measuring device operatively associated with the adjustment housing so as to provide opposing bidirectional sliding scales that are linked so as to move in a coordinated manner when simultaneously measuring opposing edges of said optimal wheel.

In yet another aspect of the subject disclosure, a wheel-fitment assembly for determining geometric properties of an optimal wheel for a hub includes the following: a removable mounting interface configured to engage the hub sufficiently to define a reference point; a diameter measuring device operatively associated with the removable mounting interface so that the diameter measuring device extends radially upward relative to the engaged hub; an adjustment housing providing offset measurement indicia, wherein the adjustment housing is slidably coupled to a distal end of the diameter measuring device so that the adjustment housing is linearly movable in a direction parallel with an axis of rotation of the engaged hub so must define an offset distance of said wheel relative to the reference point; and a width measuring device operatively associated with the adjustment housing so as to provide opposing bidirectional sliding scales that are linked so as to move in a coordinated manner when simultaneously measuring opposing width edges of said wheel.

In still yet another embodiment of the subject disclosure, the wheel-fitment assembly further includes the following: an offset marker that directly interconnects the distal end of the diameter measuring device and the adjustment housing; an adjustment link linking the opposing bidirectional sliding scales, wherein the opposing bidirectional sliding scales are linearly movable in opposing directions relative to the adjustable link, wherein the adjustment link has an elongated body and guide tracks there-along; further including, for each sliding scale, one or more guide members along a surface thereof, wherein the guide members engage the guide tracks so that linear movement of one sliding scale affects the linear movement of the other sliding scale; and, for each sliding scale, width measuring indicia is provided along another surface thereof.

In another embodiment of the subject disclosure, a method of simulating wheel width, offset, and diameter on a vehicle hub comprises mounting the above-mentioned wheel-fitment assembly to the hub, adjusting the width measuring device to establish a desired wheel width, and positioning said wheel-fitment assembly to define simulated offset and diameter.

These and other features, aspects and advantages of the present subject disclosure will become better understood with reference to the following drawings, description and claims.

### BRIEF DESCRIPTION OF THE DRAWINGS

FIG. 1 is a perspective view of an exemplary embodiment of the subject disclosure, shown in use engaged with a vehicular hub 62 (and showing the associated disc brake 64), illustrating how the wheel fitment assembly 100 provides a physical “mock-up” (wherein the bounds established by components of the assembly 100 define or delineate the relevant geometry of the optimal wheel) of an optimal wheel's offset distance, diameter, and width as, in some embodiments, the diameter measuring device 28 defines the diameter from a reference point 90 established by the removable hub mounting interface 10, as well as the optimal wheel width and offset distance when the adjustment housing 38 is operated as illustrated in FIGS. 6 and 7.

FIG. 2 is a front elevation view of an exemplary embodiment of the subject disclosure.

FIG. 3 is an exploded perspective view of an exemplary embodiment of the subject disclosure.

FIG. 4 is a side view of an exemplary embodiment of the subject disclosure.

FIG. 5 is a section view of an exemplary embodiment of the subject disclosure, taken along line 5-5 in FIG. 2.

FIG. 6 is a detailed side view of an exemplary embodiment of a width measuring device 80 of the subject disclosure, illustrating the opposing but linked movement of the sliding scales 56 and 54 when measuring or calibrating optimal wheel width as defined by the distance between the inner and outer edges of the optimal wheel.

FIG. 7 is a detailed side view of an exemplary embodiment of a width adjusting housing of the subject disclosure, illustrating the measurement or calibration of the optimal wheel offset through linearly sliding the adjustment housing 38 to different offset positions, and thus selectively shifting the associated offset measurement indicia 40 relative to the offset marker 32 when the locking nut 44 is not set.

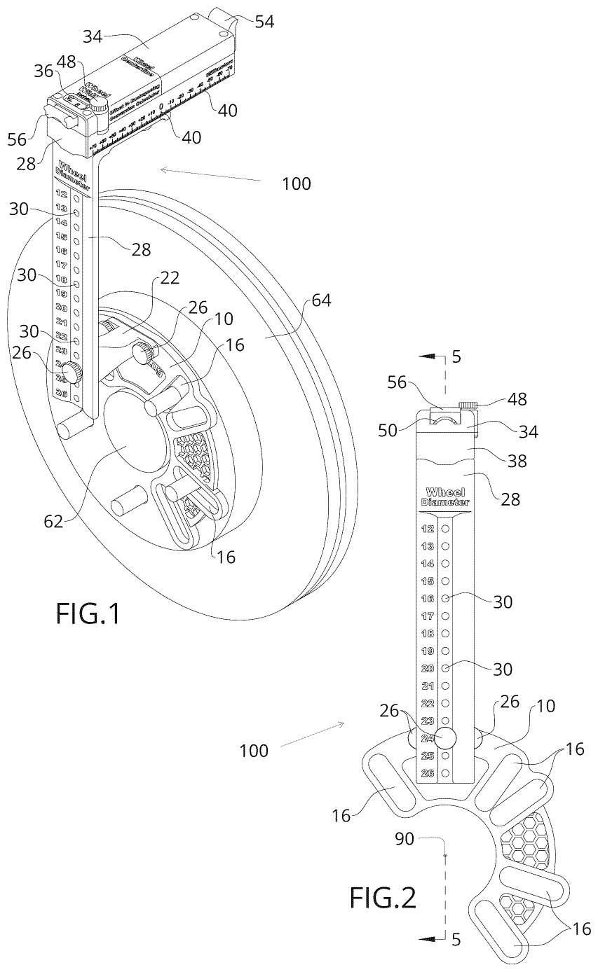

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the present subject disclosure provides a wheel-fitment assembly enabling a physical mock-up of an optimal wheel geometry for a hub that the wheel-fitment assembly physically engages. The wheel-fitment assembly integrates into a unitary apparatus an offset measuring device, a diameter measuring device, and a width measuring device to simultaneously delineate and represent the optimal wheel's offset distance, diameter, and width. The width measuring device has two bidirectional sliding scales to simultaneously define an outer edge and inner edge of the wheel width wherein the two sliding scales are mechanically communicated by an adjustment link so that movement of one sliding scale directly affects or moves the position of the other sliding scale absent a user manually resisting such movement. The adjustment link may be an elongated rod with guide tracks, wherein each sliding scale may have guide fingers that ride along opposing ends of the same guide tracks, thereby enabling the simultaneous movement of the unrestricted two bidirectional sliding scales.

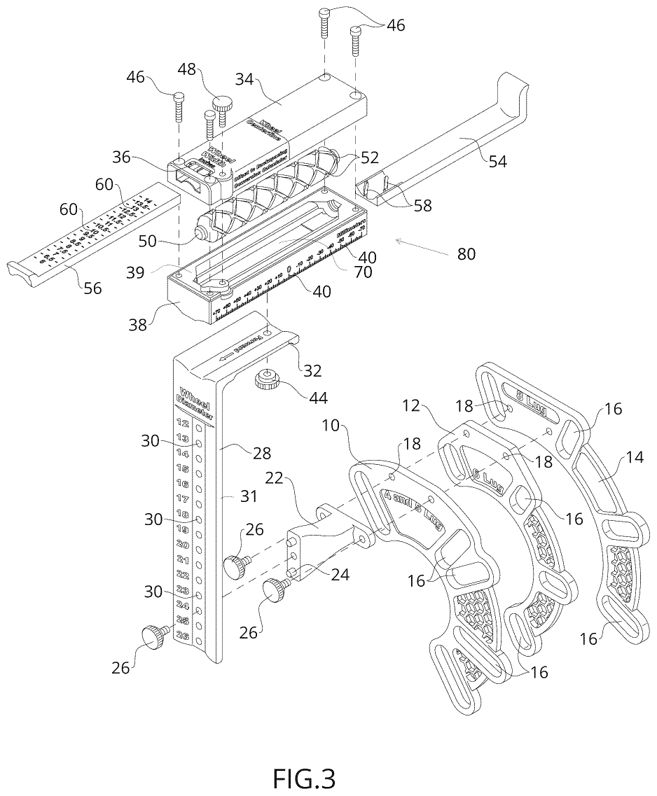

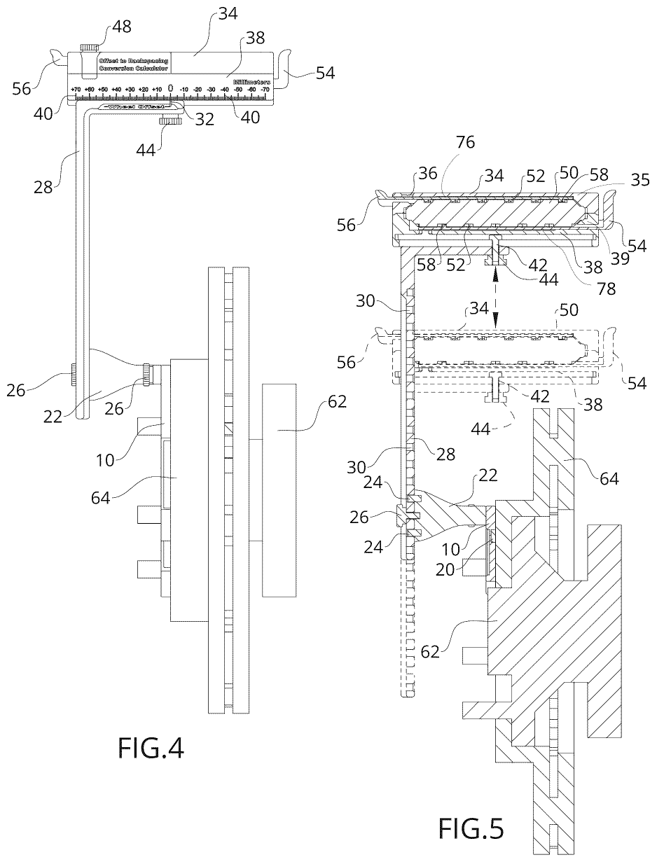

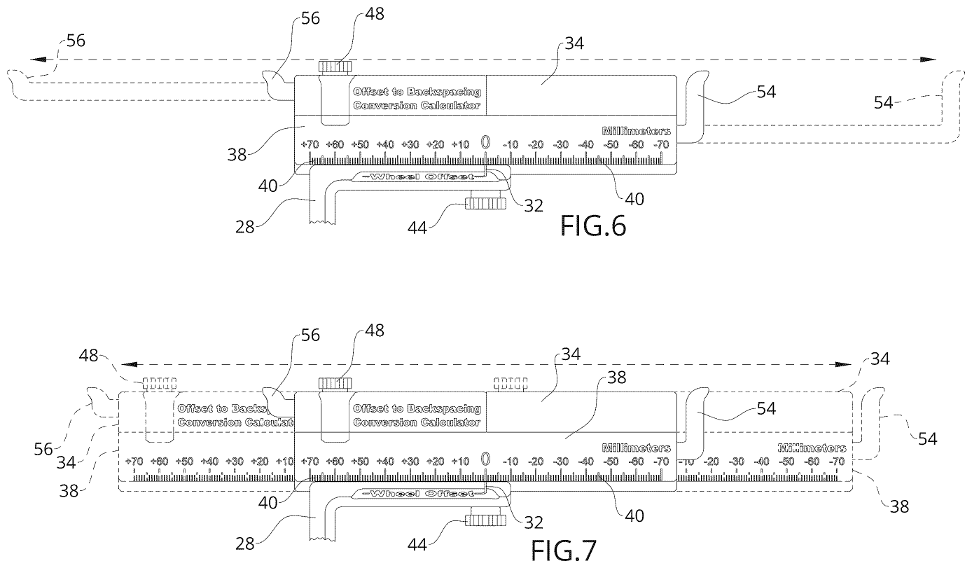

Referring to FIG. 3, the wheel-fitment assembly 100 provides one or more removable hub mounting interfaces 10, 12, and 14 for engaging with a vehicular hub 62 to define a reference point from which precise width, diameter and offset geometry of an optimal wheel can be simulated for the hub 62. The removable hub mounting interfaces 10, 12 and 14 may be an assortment of different sized and shaped plates, each having differently radially positioned or orientated lug holes 16 to facilitate engagement with differently sized, types and orientation of lugs of the vehicular hubs 62. Each removable hub mounting interface may provide connection points 18 for securing to a proximal end of an offset standoff 22. An internal magnet 20 may facilitate establishing an initial connection point between the offset standoff 22 and the removable hub mounting interface 10, 12 or 14 engaging the hub 62 of interest.

The offset standoff 22 may have a predetermined length or an adjustable length extending in the direction of the rotation axis of the hub, when the assembly 100 is engaged thereto. The offset standoff 22 extends from the proximal end, connected to the removably hub mounting interface, to an opposing distal end of the offset standoff 22. The distal end of the offset measuring device 22 may provide a pair of locating pins 24 for ensuring proper alignment between the offset standoff 22 and a connected diameter measuring device 28, in some embodiments a diameter upright.

Diameter measuring device 28 may be orthogonally connected to the offset standoff 22 to extend radially relative to the engaged hub 62. Diameter measuring device 28 may provide an array of spaced apart alignment connection points 30 provided by a body 31 of the diameter measuring device 28, wherein spacing between all two (radially) vertically adjacent alignment connection points 30 is known and the pair of locating pins 24 are received in two adjacent alignment connection points 30. It is understood that other connection apparatus may be utilized to establish this aligned connection. In any event, the alignment connection may be secured with locating fasteners 26. Again, in this alignment connection, body 31 of the diameter measuring device 28 extends radially relative to the engaged hub 62. Orthogonally extending inward (in a direction toward the engaged hub 62) from a distal end of the diameter measuring device 28 is an offset marker 32.

The offset marker 32 extends a sufficient distance to support a width measuring device 80. Width measuring device 80 includes an adjustment housing 38 (and complementary housing cover 34 thereto), wherein a locking nut 44 and locking fastener 42 may securely connect the width measuring device 80 to the offset marker 32. The adjustment housing 38 and housing cover 34 may be joined together by fasteners 46. Along longitudinal sidewalls of the width adjustment housing 38 may be offset measurement indicia 40. Measurement indicia 40 provides a linear measurement scale (in some embodiments it is a digital readout) for measuring linear distance. Thereby, the offset marker 32 in relation to offset measurement indicia 40 of the width measuring device 80, working in concert with the offset standoff 22 associated with the removable hub mounting interface, acts as an offset measuring device.

The adjustment housing 38 and housing cover 34 encases an adjustment link 50. The adjustment link 50 may be an elongated body having an intersecting pattern of guide tracks 52 along the surface of the elongated body. The adjustment housing 38 and complementary housing cover 34 may define, by way of respective build-ups 39 and 35, opposing halves of an internal cavity 70 dimensioned, sized and adapted for operatively associating with the adjustment link 50 so that the latter can rotate about a longitudinal axis even when “seated” or disposed in an encased manner. The adjustment housing 38 and complementary housing cover 34 may be elongated, i.e. extending more along a longitudinal axis than an orthogonal latitudinal axis, to accommodate the adjustment link 50. The adjustment housing 38 and housing cover 34, or their respective build-ups 39 and 35, may provide elongated association slots 78 and 76 immediately subjacent and suprajacent, respectively, of the cavity 70 associated with the adjustment link 50. Each of these association slots 78 and 76 may have distal ends that communicate with the external environment via openings on opposite sides of the adjustment housing 38 and housing cover 34, respectively. There may be no object, void or partial voids along an otherwise internal longitudinal surface of the association slots 78 and 76 so that mechanical communication is established between the housed adjustment link 50 and the sliding scales 54 and 56 slidably received with the association slots 76 and 78, respectively.

Within the subjacent association slot 78 may be a first sliding scale 54, while in the suprajacent association slot 76 may be a second sliding scale 56. Each sliding scale 54, 56 provides width measurement indicia 60 along an outward-facing surface (relative to the cavity 70 they book-end). The housing cover 34 may provide an indicator window 36 through which the width measurement indicia 60 may be visible prior to that measurement being outside the perimeter of the housing cover 34. In some embodiments the measurement indicia 60 may be incorporated in a digital readout.

Along the inward-facing surface of each sliding scale 54 and 56, are guide fingers 58 protruding further inward and dimensioned and adapted so as to simultaneously engage the intersecting guide track 52 of the adjustment link 50 when occupying their respective subjacent and suprajacent association slots 78 and 76. Accordingly, each sliding scale 54 and 56 forms a mechanical communication with the adjustment link 50 so that when the first sliding scale 54 is linearly extended in the direction of an inner edge of a to-be-determined optimal wheel width, the second sliding scale 56 is urged linearly in the opposing direction toward a to-be-calibrated outer edge of the optimal width. As a result, the width measuring device enables simultaneous bidirectional width calibration, while the interconnected diameter measuring device 28 and offset standoff 22 may be also simultaneously adjusted and redefined.

The removable hub mounting interface 10, 12, or 14, by engaging to the vehicle hub 62, establishes reference point 90 for all simulated wheel dimensions. The diameter measuring device 28 or integrated extension extending from this reference point 90 at a selected radial distance from the removable hub mounting interface 10, 12, or 14, defining and physically representing the simulated wheel diameter or the bounds thereof. Diameter measuring device 28 also establishes the lateral position of width measuring device 80 relative to reference point 90, allowing the position of adjustment housing 38 to define the simulated wheel offset while maintaining alignment of the overall assembly.

The synchronized adjustment link 50 housed within the adjustment housing 38 enables the sliding scales 54 and 56 to move in a coordinated manner. The width locking fastener 48 interacts with the adjustment housing 38 to hold positions once the desired width is set. Together these elements create a physical mock-up of wheel geometry. By adjusting the positions of the removable hub mounting interface 10, 12, or 14, the adjustment housing 38, and the diameter measuring 28 as well as the offset established by the standoff 22, the subject disclosure simulates wheel diameter, width, and offset relative to the reference point established by the removable hub mounting interface for assessing wheel fitment on a vehicle. The subject disclosure can be configured with or without vertical spacing between components, depending on the requirements of a particular vehicle design.

The subject disclosure can be made by first fabricating a hub-mounting plate that attaches to a vehicle's wheel hub using standard wheel fasteners or equivalent mounting hardware. A structural member is then formed or attached to the hub plate to support a radial arm at a selected distance from the hub plane. The radial arm is manufactured so that its outer end supports a housing that extends generally parallel to the hub face. Inside this housing, the adjustment link 50 (in some embodiments a bi-directional threaded rod) may be installed so that it is free to rotate but is restrained axially. Opposing inner and outer width-defining components are fabricated with internal thread features that mate with corresponding engagement features of the synchronized adjustment link 50, and these components are assembled into the housing so they can translate along the body of the synchronized adjustment mechanism. A locking element is then added to clamp at least one of the width-defining components after adjustment. The structural parts may be produced by 3D printing, machining, molding, or any equivalent process using rigid materials such as polymers, metals, composites, and then assembled with standard fasteners or integrated snap-fit or interference-fit joints.

The necessary elements may include a hub-mounting interface, a structural support that positions the width-adjustment housing relative to the hub, a radial member or equivalent structure that sets the simulated diameter location, the width-adjustment housing itself, the adjustment link 50, two opposing width-defining components that engage the adjustment link 50, and a locking element that secures the width once it is set. The standoff between the hub plate and the radial member can be a separate part or an integrated extension of the hub plate, and in some configurations, it may be omitted if adequate clearance is available on the vehicle. Optional elements include measurement scales for width, diameter, and offset, interchangeable hub plates for different bolt patterns, protective end caps, bushings or bearings to reduce friction, and alternative locking mechanisms such as cam clamps, detents, or quick-release levers. These optional features can improve durability, ease of use, and readability without changing the fundamental way the subject disclosure operates.

The hub-mounting plate and structural standoff may be formed as separate pieces, as shown in one embodiment, or combined into a single integrated part that both mounts to the hub and positions the radial member. The radial arm and width-adjustment housing can likewise be produced as a single monolithic component or as multiple pieces fastened together, so long as the housing is positioned at the desired radial distance and offset relative to the hub plane. The synchronized width adjustment can be implemented using a single bi-directional threaded rod, multiple rods coupled together, or an equivalent mechanism such as a gear-driven linkage, cam system, belt-driven synchronizing system, or opposing rack-and-pinion arrangement that moves the inner and outer width-defining components symmetrically. In alternative embodiments, the width may be established using interchangeable fixed width inserts or modules that position the wheel lips at predetermined distances without moving components. The locking feature may clamp directly to one of the width-defining components, to the adjustment link 50, or to the housing, if it prevents unintended movement once the desired width is set. Hub plates, wheel-lip geometries, and measurement features can be interchanged, integrated, or relocated to accommodate different vehicles and wheel profiles while still performing the same overall function of simulating wheel width, diameter, and offset on the vehicle.

To use the subject disclosure, the user attaches the removable mounting interface to the vehicle's hub using the existing wheel studs or equivalent mounting hardware. With the tool secured, the user positions the adjustment housing at the desired offset location by adjusting the housing's position relative to the hub plate. Then the user may adjust either wheel lip slider by extending or retracting these width-defining components within the width adjustment housing. This movement causes the opposing wheel-lip component to move in a coordinated manner through the synchronized adjustment mechanism inside the housing, establishing the simulated wheel width. Once the desired width is reached, the user engages the width lock to secure the setting. The user then verifies or adjusts the simulated wheel diameter by referencing the position of the diameter upright relative to the hub plate. With diameter, width, and offset each set, the assembled mock-up represents the geometry of a real wheel. The user can rotate or steer the vehicle's knuckle, compress the suspension, and observe whether the simulated wheel envelope contacts surrounding structures such as fenders, suspension arms, or other nearby components. If the adjustment housing contacts a brake component during this process, such contact may indicate that a wheel of larger diameter could be required.

Additionally, the underlying adjustable and synchronized positioning mechanism can be applied in other fields that require controlled spacing between two or more components. The adjustments could also be performed or assisted by powered actuators, sensors, or automated positioning systems if implemented in a machine-controlled environment. The same principles may be used in mock-ups, fixtures, measurement tools, or alignment devices in other mechanical or manufacturing contexts.

Also, the subject disclosure is a useful mechanical device that provides a physical simulation of wheel geometry for evaluating fitment on a vehicle. It does not create or manufacture another product, but the subject disclosure is a complete and useful item in its assembled form.

As used in this application, the term “about” or “approximately” refers to a range of values within plus or minus 10% of the specified number. Recitation of ranges of values herein is not intended to be limiting, referring instead individually to any and all values falling within the range, unless otherwise indicated, and each separate value within such a range is incorporated into the specification as if it were individually recited herein. The term “substantially” is used in a descriptive sense and does not require complete or absolute correspondence unless expressly stated.

For purposes of this disclosure, the term “aligned” generally refers to components arranged in parallel or substantially parallel orientation. For purposes of this disclosure, the term “transverse” generally refers to components arranged in perpendicular or substantially perpendicular orientation.

Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affects the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A wheel-fitment assembly for determining geometric properties of a wheel for a hub, the wheel-fitment assembly comprising:
a removable mounting interface configured to engage the hub sufficiently to define a reference point;
a diameter measuring device operatively associated with the removable mounting interface so that the diameter measuring device extends radially upward relative to the engaged hub;
an adjustment housing providing offset measurement indicia, wherein the adjustment housing is slidably coupled to a distal end of the diameter measuring device so that the adjustment housing is linearly movable in a direction parallel with an axis of rotation of the engaged hub so must define an offset distance of said wheel relative to the reference point; and
a width measuring device operatively associated with the adjustment housing so as to provide opposing bidirectional sliding scales that are linked so as to move in a coordinated manner when simultaneously measuring opposing width edges of said wheel.

2. The wheel-fitment assembly of claim 1, further comprising an offset marker that directly interconnects the distal end of the diameter measuring device and the adjustment housing.

3. The wheel-fitment assembly of claim 1, further comprising an adjustment link linking the opposing bidirectional sliding scales.

4. The wheel-fitment assembly of claim 3, wherein the opposing bidirectional sliding scales are linearly movable in opposing directions relative to the adjustable link.

5. The wheel-fitment assembly of claim 4, wherein the adjustment link has an elongated body and guide tracks there-along.

6. The wheel-fitment assembly of claim 5, further comprising, for each sliding scale, one or more guide members along a surface thereof, wherein the guide members engage the guide tracks so that linear movement of one sliding scale affects the linear movement of the other sliding scale.

7. The wheel-fitment assembly of claim 6, further comprising, for each sliding scale, width measuring indicia is provided along another surface thereof.

8. A wheel-fitment assembly comprising:
a removable mounting interface configured to engage the hub sufficiently to define a reference point; and
a width measuring device operatively associated with the reference point, wherein the width measuring device provides opposing bidirectional sliding scales that are linked so as to move in a coordinated manner when simultaneously measuring opposing width edges of a wheel for the engaged hub.

9. The wheel-fitment assembly of claim 8, further comprising an adjustment link linking the opposing bidirectional sliding scales.

10. The wheel-fitment assembly of claim 9, wherein the opposing bidirectional sliding scales are linearly movable in opposing directions relative to the adjustable link.

11. The wheel-fitment assembly of claim 10, wherein the adjustment link has an elongated body and guide tracks there-along.

12. The wheel-fitment assembly of claim 11, further comprising, for each sliding scale, one or more guide members along a surface thereof, wherein the guide members engage the guide tracks so that linear movement of one sliding scale affects the linear movement of the other sliding scale.

13. The wheel-fitment assembly of claim 12, further comprising, for each sliding scale, width measuring indicia is provided along another surface thereof.

14. A method of simulating wheel width, offset, and diameter on a vehicle hub comprises mounting the wheel-fitment assembly of claim 1 to the hub, adjusting the width measuring device to establish a desired wheel width, and positioning said wheel-fitment assembly to define simulated offset and diameter.
